(19) United States
(12) Patent Application Publication
(10) Pub. No.: US 2023/0359866 A1
(43) Pub. Date: Nov. 9, 2023

(54) GRAPH EMBEDDING METHOD AND SYSTEM THEREOF

(71) Applicant: SAMSUNG SDS CO., LTD., Seoul (KR)

(72) Inventors: Jae Sun SHIN, Seoul (KR); Young June Gwon, Seoul (KR)

(73) Assignee: SAMSUNG SDS CO., LTD., Seoul (KR)

(21) Appl. No.: 18/142,897

(22) Filed: May 3, 2023

(30) Foreign Application Priority Data
May 4, 2022 (KR) 10-2022-0055525
Oct. 18, 2022 (KR) 10-2022-0133768

(51) Int. Cl. G06N 3/045

(52) U.S. Cl. CPC G06N 3/045

(57) ABSTRACT

A graph embedding method and system thereof are provided. The graph embedding method according to some embodiments includes acquiring a first embedding representation and a second embedding representation of a target graph; changing the second embedding representation by reflecting a specific value into the second embedding representation; and generating an integrated embedding representation by aggregating the first embedding representation and the changed second embedding representation.

### CROSS-REFERENCE TO RELATED APPLICATION(S)

This application claims priority from Korean Patent Application No. 10-2022-0055525 filed on May 4, 2022 and Korean Patent Application No. 10-2022-0133768 filed on Oct. 18, 2022 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a graph embedding method and system.

### 2. Description of the Related Art

Graph embedding refers to converting a graph into a vector or matrix in an embedding space. Recently, research has been vigorously conducted on ways to embed graphs using a neural network, and such neural network is referred to as a graph neural network (GNN).

Different GNNs (e.g., GNNs having different structures or operating in different manners) produce different embedding vectors for the same graph. Thus, if embedding vectorscan be integrated without loss of information (or loss of expressive power), more powerful embedding representations can be created.

In order to prevent loss of information during the integration of individual embedding vectors, a method of generating an integrated embedding vector by concatenating the individual embedding vectors together may be considered. However, this method clearly has a problem that the complexity of tasks (e.g., downstream tasks such as classification and regression) associated with the dimension quantity of an integrated embedding vector increases proportionally to the number of individual embedding vectors to be concatenated together to form the integrated embedding vector.

### SUMMARY

An aspect of an example embodiment of the present disclosure provides a graph embedding method capable of integrating various embedding representations of a graph without loss of information (or loss of expressive power) and a system performing the graph embedding method.

An aspect of an example embodiment of the present disclosure provides a graph embedding method capable of integrating various embedding representations of a graph without increasing the complexity of any associated tasks and a system performing the graph embedding method.

An aspect of an example embodiment of the present disclosure provides a graph embedding method capable of embedding a graph together with node information and topology information of the graph and a system performing the graph embedding method.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of an example embodiment of the present disclosure, there is provided a graph embedding method performed by at least one computing device. The graph embedding method includes acquiring a first embedding representation and a second embedding representation of a target graph, changing the second embedding representation by reflecting a specific value into the second embedding representation, and generating an integrated embedding representation by aggregating the first embedding representation and the changed second embedding representation.

In some embodiments, one of the first embedding representation and the second embedding representation may be generated by an embedding method that aggregates information of neighbor nodes that form the target graph, and the other one of the first embedding representation and the second embedding representation may be generated by an embedding method that reflects topology information of the target graph.

In some embodiments, the first embedding representation and the second embedding representation may be generated by embedding the target graph via different graph neural networks (GNNs).

In some embodiments, the specific value may be an irrational number.

In some embodiments, the specific value may be a value based on a learnable parameter, and the graph embedding method may further include predicting a label for a predefined task based on the integrated embedding representation, and updating a value of the learnable parameter based on a result of the predicting.

In some embodiments, the reflecting the specific value into the second embedding representation may be performed based on a multiplication operation, and the aggregating the first embedding representation and the changed second embedding representation may be performed based on an addition operation.

In some embodiments, the acquiring the first embedding representation and the second embedding representation may include acquiring a first embedding matrix and a second embedding matrix of the target graph, the first embedding representation and the second embedding representation having different sizes, and acquiring the first embedding representation and the second embedding representation by performing a resizing operation on at least one of the first embedding matrix and the second embedding matrix.

In some embodiments, the acquiring the first embedding representation and the second embedding representation may include acquiring the first embedding representation via a neighbor node information aggregation scheme-based GNN, and acquiring the second embedding representation by extracting topology information of the target graph using the first embedding representation.

In some embodiments, the generating the integrated embedding representation may include performing a pooling operation on the first embedding representation and the changed second embedding representation, and generating the integrated embedding representation by aggregating results of the pooling operation.

In some embodiments, the generating the integrated embedding representation may include acquiring a third embedding representation of the target graph, changing the third embedding representation by reflecting another specific value into the third embedding representation, and generating the integrated embedding representation by aggregating the first embedding representation, the changed second embedding representation, and the changed third embedding representation.

In some embodiments, the generating the integrated embedding representation may include acquiring a third embedding representation through a k-th embedding representation (k being a natural number of 3 or greater), changing the third embedding representation through the k-th embedding representation by reflecting another specific value into the third embedding representation through the k-th embedding representation, and generating the integrated embedding representation by aggregating the first embedding representation, the changed second embedding representation, and the changed third embedding representation through k-th embedding representation.

According to an aspect of an example embodiment of the present disclosure, there is provided a graph embedding system. The graph embedding system includes at least one processor, and a memory configured to store program code executable by the at least one processor, the program code including: acquiring code configured to cause the at least one processor to acquire a first embedding representation and a second embedding representation of a target graph; changing code configured to cause the at least one processor to change the second embedding representation by reflecting a specific value into the second embedding representation; and generating code configured to cause the at least one processor to generate an integrated embedding representation by aggregating the first embedding representation and the changed second embedding representation.

According to an aspect of an example embodiment the present disclosure, there is provided a non-transitory computer-readable recording medium storing program code executable by at least one processor, the program code including: acquiring code configured to cause the at least one processor to acquire a first embedding representation and a second embedding representation of a target graph; changing code configured to cause the at least one processor to change the second embedding representation by reflecting a specific value into the second embedding representation; and generating code configured to cause the at least one processor to generate an integrated embedding representation by aggregating the first embedding representation and the changed second embedding representation.

According to the aforementioned and other embodiments of the present disclosure, an integrated embedding representation of a target graph may be generated by reflecting a specific value into at least some of a variety of individual embedding representations of the target graph and then aggregating the individual embedding representations. In this case, as different embedding representations may be prevented from cancelling each other out during aggregation, various embedding representations may be integrated without loss of information (or expressive power). For example, the cancellation of different embedding representations may be effectively prevented by multiplying at least one of the different embedding representations by an irrational number during aggregation (e.g., addition).

Also, the specific value may be deduced based on a learnable parameter. Thus, as learning for generating an integrated embedding representation proceeds, an optimal specific value capable of preventing loss of information (or expressive power) in individual embedding representations may be produced naturally and accurately.

Also, various embedding representations (e.g., embedding vectors) of a target graph may be aggregated by an addition operation. In this case, as the size (or the dimension quantity) of an integrated embedding representation does not increase regardless of an increase in the number of individual embedding representations to be aggregated, problems such as an increase in the complexity of any associated task (e.g., a downstream task such as classification or regression) may be easily addressed.

Also, even embedding representations (e.g., embedding matrices) having different sizes may be easily integrated by a resizing operation implemented based on a multilayer perceptron.

Also, a robust integrated embedding representation of a target graph may be generated by integrating a node information-based embedding representation and a topology information-based embedding representation, and by using the integrated embedding representation, the accuracy of various tasks associated with graphs (e.g., downstream tasks such as classification or regression) may be considerably improved.

Also, a second embedding representation may be generated by extracting topology information of a target graph from a first embedding representation output via a neighbor node information aggregation module. In this case, as the neighbor node information aggregation module functions as a type of shared neural network, an integrated graph neural network (GNN) capable of generating (or outputting) an integrated embedding representation may be easily established.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing in detail exemplary embodiments thereof with reference to the attached drawings, in which:

FIGS. 1 and 2 are block diagrams illustrating an operation of a graph embedding system according to some embodiments of the present disclosure;

FIGS. 3 and 4 are block diagrams illustrating a neighbor node information aggregation scheme-based graph neural network (GNN) that may be referenced in some embodiments of the present disclosure;

FIGS. 5 and 6 are block diagrams illustrating a topology information extraction scheme-based GNN that may be referenced in some embodiments of the present disclosure;

FIG. 7 is a flowchart illustrating a graph embedding method according to some embodiments of the present disclosure;

FIG. 8 illustrates the graph embedding method of FIG. 7;

FIG. 9 illustrates a learning process for the graph embedding method of FIG. 7;

FIG. 10 illustrates a graph embedding method according to some embodiments of the present disclosure;

FIG. 11 illustrates a graph embedding method according to some embodiments of the present disclosure;

FIGS. 12 and 13 are block diagrams illustrating a graph embedding method according to some embodiments of the present disclosure; and

FIG. 14 is a block diagram of a computing device that may implement a graph embedding system according to some embodiments of the present disclosure.

### DETAILED DESCRIPTION

Hereinafter, example embodiments of the present disclosure will be described with reference to the attached drawings. Advantages and features of the present disclosure and methods of accomplishing the same may be understood more readily by reference to the following detailed description of example embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that may be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), may be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Embodiments of the present disclosure will be described with reference to the attached drawings.

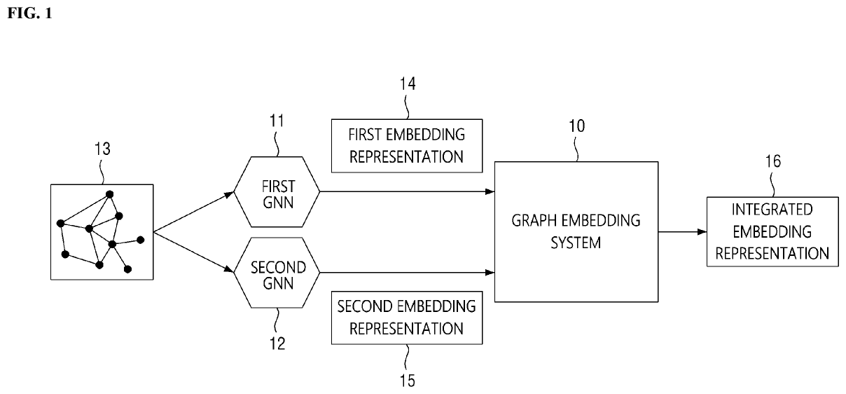

FIG. 1 is a block diagram of a graph embedding system 10 according to some embodiments of the present disclosure.

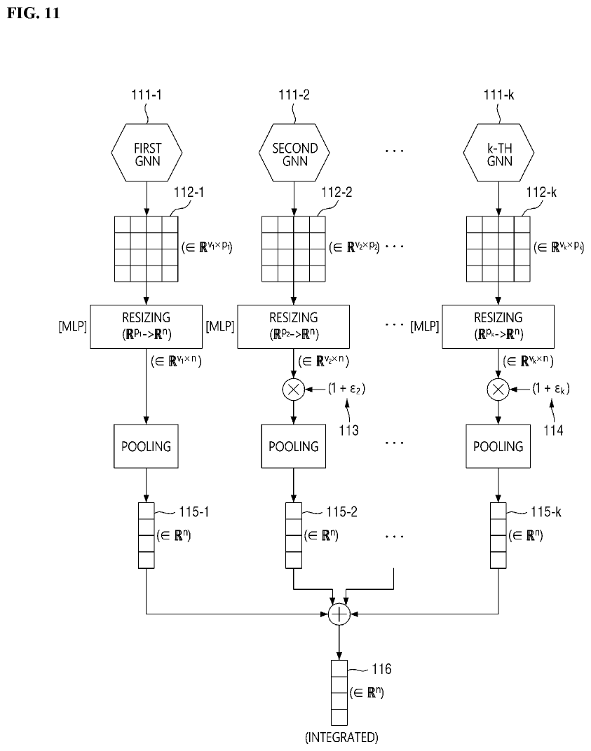

Referring to FIG. 1, the graph embedding system 10 may be a computing device/system capable of generating embedding representations of a graph 13. Specifically, the graph embedding system 10 may generate an integrated embedding representation 16 of the graph 13 by integrating various individual embedding representations of the graph 13, i.e., first and second embedding representations 14 and 15. FIG. 1 illustrates that the graph embedding system 10 uses two graph neural networks (GNNs), i.e., first and second GNNs 11 and 12, and two individual embedding representations, i.e., the first and second embedding representations 14 and 15, but the present disclosure is not limited thereto. That is, the number of GNNs used and/or the number of individual embedding representations to be integrated may be 3 or greater (see FIG. 11). For convenience, the graph embedding system 10 will hereinafter be referred to simply as the graph embedding system 10.

The first and second embedding representations 14 and 15 may refer to vector or matrix representations of the graph 13. Here, the term “matrix” may encompass the concept of a tensor, and the term “embedding representation” may also be referred to as an embedding vector, matrix, or code or a latent representation, depending on cases (or types).

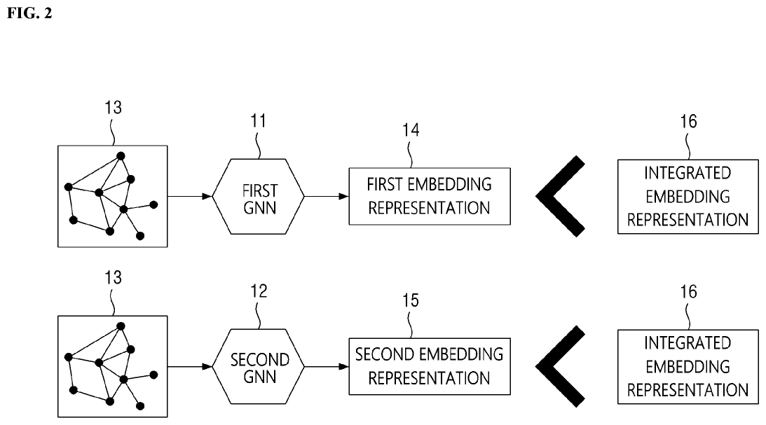

The first embedding representation 14 may include at least some graph information different from the second embedding representation 15 or may be generated from a different GNN from the second embedding representation 15. For example, the first embedding representation 14 may be generated from the first GNN 11, and the second embedding representation 15 may be generated from the second GNN 12, which has a different expressive power from the first GNN 11. In this example, as illustrated in FIG. 2, the graph embedding system 10 may generate an integrated embedding representation 16 having a stronger expressive power (or enriched with more information) by integrating the first and second embedding representations 14 and 15. For example, in a case where the first embedding representation 14 is generated from the first GNN 11, which is a neighbor node information aggregation scheme-based GNN, and the second embedding representation 15 is generated from the second GNN 12, which is a topology information extraction scheme-based-based GNN, the graph embedding system 10 may generate an integrated embedding representation 16 having both neighbor node information and topology information of the graph 13 reflected thereinto by integrating the two individual embedding representations, i.e., the first and second embedding representations 14 and 15. This will be described later with reference to FISG. 3 through 6, 12, and 13.

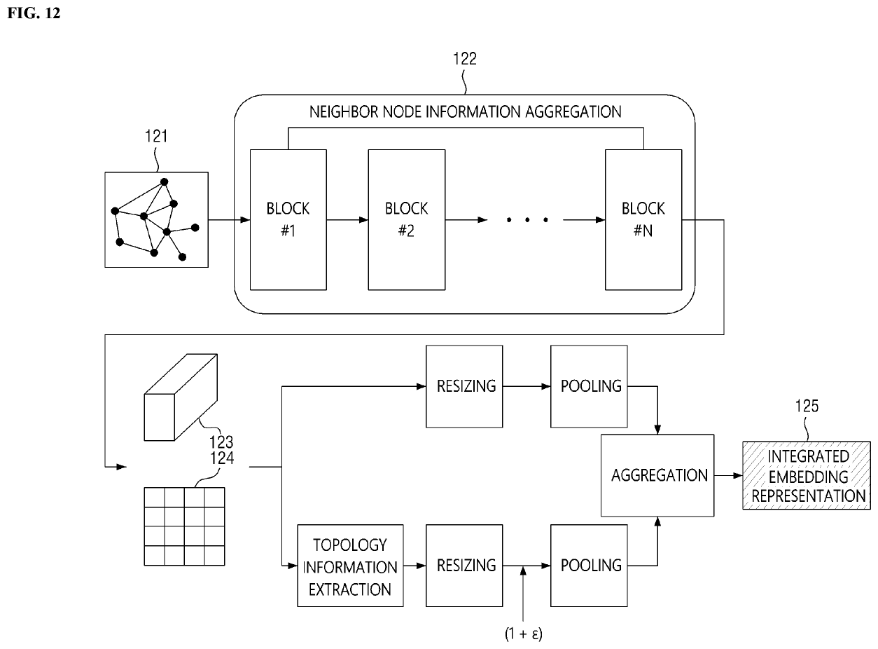

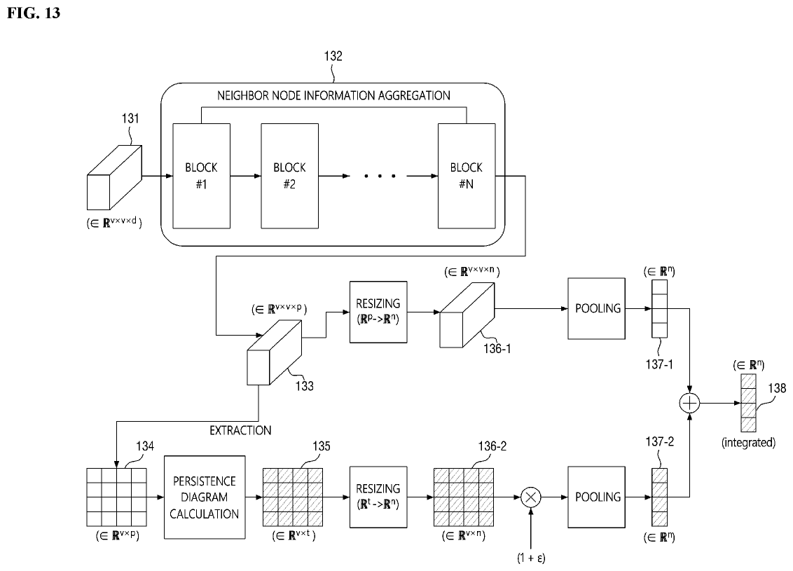

The first and second embedding representations 14 and 15 may be the final outputs of the first and second GNNs 11 and 12 or may be intermediate products of the first and second GNNs 11 and 12 that result from inner processing performed in the first and second GNNs 11 and 12. The first and second GNNs 11 and 12 may refer to different models or different parts of the same model (e.g., an integrated model of FIG. 12 or 13). Also, the first and second GNNs 11 and 12 may or may not be learned models.

GNNs (or embedding representations) having different expressive powers may mean that the GNNs produce different embedding representations (e.g., embedding representations having different embedded information) for the same graph or classifies the same graph into different graph classes. Specifically, it is assumed that when the task of classifying first through fourth graphs is performed using embedding representations of the first and second GNNs 11 and 12, the first and second graphs, but not the third and fourth graphs, are distinguished from each other (i.e., classified into different graph classes) by the first GNN 11, which is, for example, a neighbor node information aggregation scheme-based GNN, whereas the third and fourth graphs, but not the first and second graphs, are distinguished from each other (i.e., classified into different graph classes) by the second GNN 12, which is, for example, a topology information extraction scheme-based-based GNN. In this case, the first and second GNNs may be understood as having different expressive powers.

Also, when the first GNN 11 (or the first embedding representation 14) is referred to as having a stronger expressive power than the second GNN 12 (or the second embedding representation 15), the first GNN 11 (or the first embedding representation 14) may contain more information than the second GNN 12 (or the second embedding representation 15) or may mean that the set of graphs classified the first GNN 11 is larger that of the second GNN 12. Specifically, it is assumed that when the task of classifying first through fourth graphs is performed using the embedding representations of the first and second GNNs 11 and 12, all ten graphs may be distinguished from one another using the embedding representations of the first GNN 11, but some of the ten graphs may not be able to be distinguished from one another using the embedding representations of the second GNN 12. In this case, the first GNN 12 may be understood as having a stronger expressive power than the second GNN 12 and being a more excellent model capable of better reflecting variations into an input graph to generating embedding representations than the second GNN 12.

The graph embedding system 10 may learn modules (e.g., GNNs or resizing modules) and parameters for generating the integrated embedding representation 16 by performing a predefined task (e.g., classification or regression). If a target task of the integrated embedding representation 16 is already determined, the graph embedding system 10 may perform learning using the target task.

The graph embedding system 10 may perform the target task by using the learned modules and parameters or may provide the integrated embedding representation 16 to a device so that the device may perform the target task.

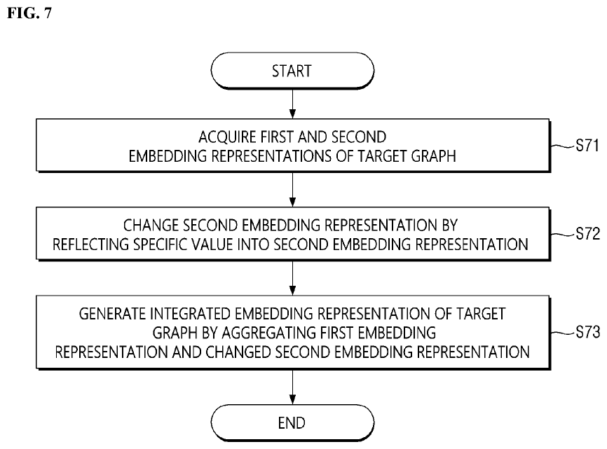

It will be described later how the graph embedding system 10 generates the integrated embedding representation 16 with reference to FIGS. 7 through 9.

The graph embedding system 10 may be implemented as at least one computing device. For example, all the functions of the graph embedding system 10 may be implemented in a single computing device, different functions of the graph embedding system 10 may be implemented in different computing devices, or a particular function of the graph embedding system 10 may be implemented in two or more computing devices.

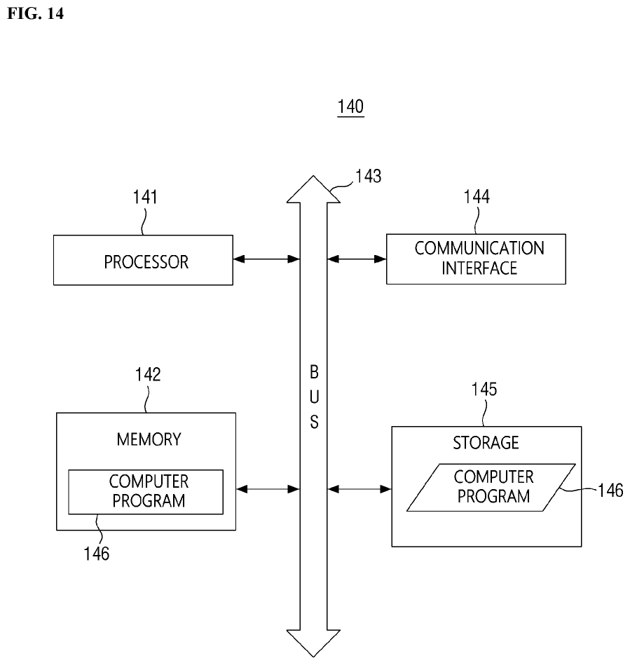

Here, the term “computing device” may encompass nearly all types of arbitrary devices equipped with a computing function, and an exemplary computing device will be described later with reference to FIG. 14. A computing device, which is a set of various components or elements (e.g., memories or processors) that interact with one another, may also be referred to as a computing system, which may also refer to a set of multiple computing devices that interact with one another.

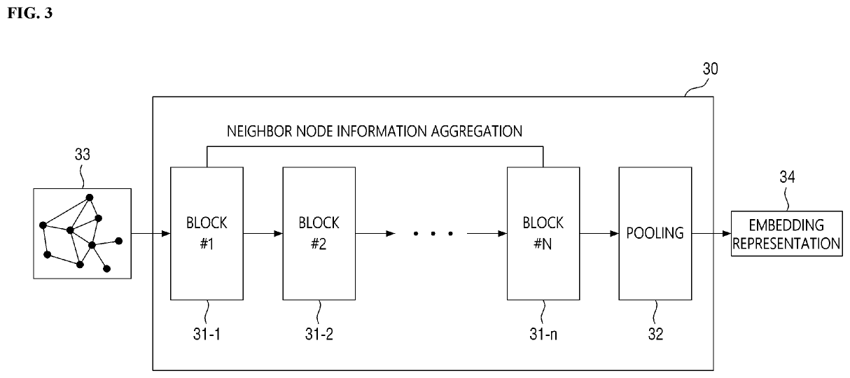

The operation of the graph embedding system 10 has been described so far with reference to FIGS. 1 and 2. Neighbor node information aggregation scheme-based GNNs and topology information extraction scheme-based GNNs will hereinafter be described with reference to FIGS. 3 through 6.

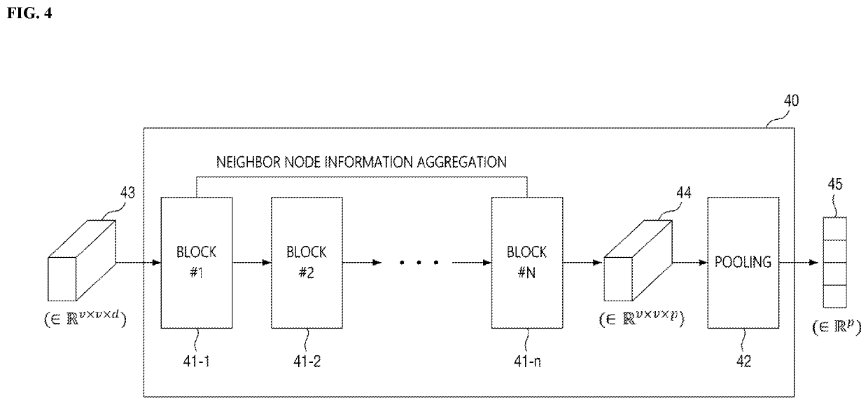

The structure and operation of a neighbor node information aggregation scheme-based GNN will hereinafter be described with reference to FIGS. 3 and 4.

FIG. 3 illustrates a neighbor node information aggregation scheme-based GNN that may be referenced in some embodiments of the present disclosure.

Referring to FIG. 3, a GNN 30 may receive a graph 33 (or graph data) and may generate an embedding representation 34 for the graph 33 by repeatedly aggregating information of neighbor nodes (or features). To this end, the GNN 30 may be configured to include a plurality of first through n-th blocks 31-1 through 31-n and a pooling module 32 and may further include other modules (not illustrated), in some embodiments.

The first through n-th blocks 31-1 through 31-n may repeatedly aggregate information of neighbor nodes that form the graph 33. The first through n-th blocks 31-1 through 31-n may be configured as multilayer perceptrons (i.e., fully-connected layers), but the present disclosure is not limited thereto.

The pooling module 32 may generate (or output) the embedding representation 34 of an appropriate size by performing a pooling operation. The pooling operation is already well known in the art to which the present disclosure pertains, and thus, a detailed description thereof will be omitted. The pooling module 32 may also be referred to as a pooling layer, a readout layer, or a readout module.

The embedding representation 34, which is generated by the GNN 30, may well reflect node information of the graph 33, but does not reflect topology information of the graph 33 (e.g., information on the general shape of the graph 33). Thus, if the embedding representation 34 is used to perform a task that the topology information of the graph 33 plays an important role in, the performance of the corresponding task may be degraded.

The GNN 30 will be described in further detail with reference to FIG. 4.

Referring to FIG. 4, a GNN 40 may receive a feature matrix 43, which is a three-dimensional (3D) matrix having a size of v*v*d (where v denotes the number of nodes for a node tuple and d denotes the dimension quantity of each feature) and may generate (or output) an embedding vector 45 (e.g., a p-dimensional embedding vector).

Specifically, the GNN 40 may generate an embedding matrix (e.g., a 3D matrix having a size of v*v*p) for the node tuple by repeatedly aggregating the feature matrix 43 via a plurality of first through n-th blocks 41-1 through 41-n, and may finally generate (or output) the embedding vector 45 for an input graph via a pooling module 42.

A GNN such as a provably powerful graph network (PPGN) may operate in a similar manner to the GNN 40 of FIG. 4 (for more information on a PPGN, see the article entitled “Provably Powerful Graph Network”).

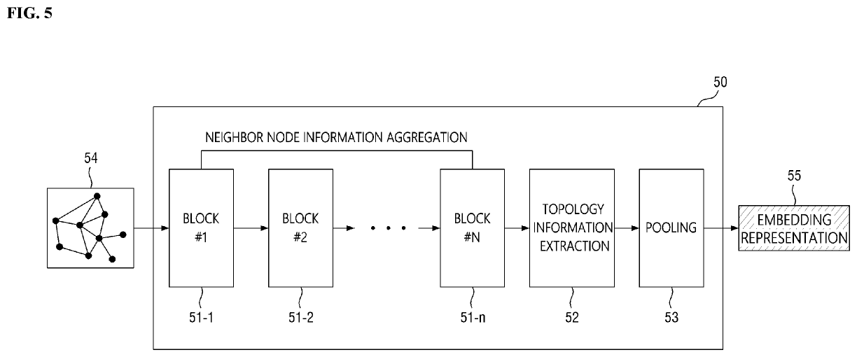

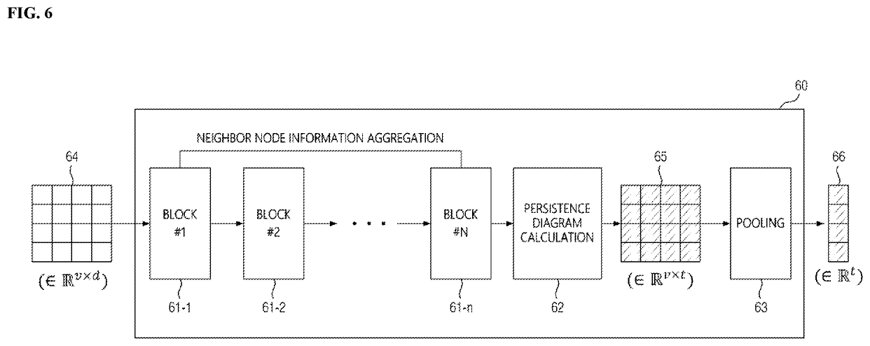

The structure and operation of a topology information extraction scheme-based-based GNN will hereinafter be described with reference to FIGS. 5 and 6.

FIG. 5 illustrates a topology information extraction scheme-based-based GNN that may be referenced in some embodiments of the present disclosure.

Referring to FIG. 5, a GNN 50 may generate an embedding representation 55 of a graph 54 by reflecting topology information extracted from the graph 54. In FIG. 5 and the subsequent figures, embedding representations shaded with oblique lines, such as the embedding representation 55, are embedding representations with topology information reflected thereinto.

The GNN 50 may be configured to include a plurality of first through n-th blocks 51-1 through 51-n, a topology information extraction module 52, and a pooling module 53 and may further include other modules (not illustrated), in some embodiments.

The GNN 50, like the GNN 30, may repeatedly aggregate information of neighbor nodes that form the graph 54. The first through n-th blocks 51-1 through 51-n may be configured as multilayer perceptrons (i.e., fully-connected layers), but the present disclosure is not limited thereto.

The topology information extraction module 52 may extract the topology information of the graph 54. For example, the topology information extraction module 52 may extract the topology information of the graph 54 by calculating a persistence diagram. The persistence diagram and how to calculate the persistence diagram are already well known in the art to which the present disclosure pertains, and thus, detailed descriptions thereof will be omitted.

The pooling module 53 may generate (or output) the embedding representation 54 of an appropriate size by performing a pooling operation.

The embedding representation 55, which is generated by the GNN 50, may well reflect the topology information of the graph 54, but does not reflect node information of the graph 54. Thus, if the embedding representation 55 is used to perform a task that the node information of the graph 54 plays an important role in, the performance of the corresponding task may be degraded.

The GNN 50 will hereinafter be described in further detail with reference to FIG. 6.

Referring to FIG. 6, a GNN 60 may receive a feature matrix 64, which is a two-dimensional (2D) matrix having a size of v*d (where v denotes the number of nodes and d denotes the dimension quantity of each feature) and may generate (or output) an embedding vector 65 (e.g., a t-dimensional embedding vector) for each node.

Specifically, the GNN 60 may generate an embedding matrix for each node by repeatedly aggregating the feature matrix 64 via a plurality of first through n-th blocks 41-1 through 41-n, and may finally generate (or output) the embedding vector 65 for an input graph via a pooling module 63.

A GNN such as graph filtration learning (GFL) may operate in a similar manner to the GNN 60 of FIG. 6 (for more information on GFL, see the article entitled “Graph Filtration Learning”).

The GNNs that may be referenced in some embodiments of the present disclosure, i.e., the GNNs 30, 40, 50, and 60, have been described so far with reference to FIGS. 3 through 6. Various methods that may be performed by the graph embedding system 10 will hereinafter be described with reference to FIG. 7 and the subsequent figures. For convenience, although not specifically mentioned, it is assumed that all steps and/or operations of each method that will hereinafter be described are performed by the graph embedding system 10. However, some of the steps and/or operations may actually be performed in a computing device other than the graph embedding system 10.

A graph embedding method according to some embodiments of the present disclosure will hereinafter be described with reference to FIGS. 7 through 9.

The embodiment of FIGS. 7 through 9 relates to a method of integrating two embedding representations of a target graph. A method of integrating three or more embedding representations of a target graph will be described later with reference to FIG. 11.

FIG. 7 is a flowchart illustrating a graph embedding method according to some embodiments of the present disclosure. The graph embedding method of FIG. 7, however, is merely exemplary, and some steps may be added to, or deleted from, the graph embedding method of FIG. 7.

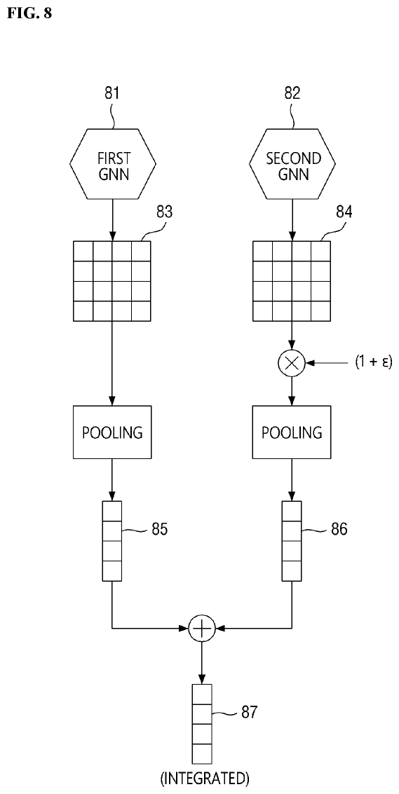

Referring to FIG. 7, the graph embedding method may begin with S71, which is the step of acquiring first and second embedding representations of a target graph. For example, referring to FIG. 8, the graph embedding system 10 may acquire first and second embedding representations 83 and 84 via first and second GNNs 81 and 82, respectively, which have different expressive powers. The first and second GNNs 81 and 82 may be neighbor node information aggregation scheme- and topology information extraction scheme-based GNNs, respectively, that have been described above with reference to FIGS. 3 and 4 and FIGS. 5 and 6, respectively, but the present disclosure is not limited thereto. The first embedding representation 83 may be, but is not limited to, a node information-based embedding representation generated by aggregating information (e.g., feature information) of neighbor nodes of the target graph, and the second embedding representation 83 may be, but is not limited to, a topology information-based embedding representation generated by reflecting topology information of the target graph.

As already mentioned above, the first and second embedding representations may be the final outputs of GNNs or may be intermediate products of GNNs and 82 that result from inner processing performed in the GNNs. For example, the first and second embedding representations may be embedding vectors obtained by a pooling operation or may be embedding matrices (e.g., 2D or 3D matrices) obtained before a pooling operation. If the first and second embedding representations are embedding vectors obtained by a pooling operation, a pooling operation may not be performed, unlike as illustrated in FIG. 8.

In S72, a specific value (e.g., a scalar value) may be reflected into the second embedding representation, and as a result, the second embedding representation may be changed. For example, referring to FIG. 8, the graph embedding system 10 may reflect a specific value of ±ε into the second embedding representation 84 via a multiplication operation (e.g., multiply elements of an embedding matrix by the specific value of +ε). Here, the specific value of ±ε may be reflected into the second embedding representation 84 to prevent the first and second embedding representations 83 and 84 from cancelling each other out during aggregation (e.g., an addition operation), because the cancellation of the first and second embedding representations 83 and 83 means loss of information (or expressive power) of the first and second embedding representations 83 and 84.

FIG. 8 illustrates that the specific value of ±ε is reflected only in the second embedding representation 84, but the present disclosure is not limited thereto. Alternatively, the graph embedding system 10 may reflect the specific value of ±ε in the first embedding representation 83, rather than in the second embedding representation 84. Alternatively, the graph embedding system 10 may reflect a first specific value in the first embedding representation 83 and may reflect a second specific value, which is different from the first specific value, in the second embedding representation 84.

A method to deduce (or generate) the specific value may vary.

In some embodiments, the specific value may be set in advance. For example, the specific value, which is a value based on a type of hyperparameter (e.g., E), may be set in advance by a user. For example, the specific value may be set to an irrational number because the cancelation of two embedding representations may be effectively prevented by multiplying one (or both) of the two embedding representations by an irrational number during aggregation (e.g., an addition operation).

Alternatively, in some embodiments, the specific value may be a value based on a learnable parameter. If the learnable parameter is E, the specific value may be the value of E itself or may be the sum of E and an irrational number. The graph embedding system 10 may predict the label of a predefined task (i.e., a task for learning) using an integrated embedding representation and may update the value of the learnable parameter based on the difference between the predicted label and a correct label (i.e., the exact label of the target graph). In this case, as learning for generating an integrated embedding representation proceeds, an optimal specific value capable of preventing loss of information (or expressive power) in individual embedding representations may be produced naturally and accurately.

In S73, an integrated embedding representation of the target graph may be generated by aggregating the first and second embedding representations. For example, referring to FIG. 8, the graph embedding system 10 may generate an integrated embedding representation (e.g., an embedding vector) of the target graph by performing a pooling operation on each of the first embedding representation 83 and a changed second embedding representation (not illustrated) and aggregating first and second pooled embedding representations 85 and 86 obtained by the pooling operation. If the first and second embedding representations 83 and 84 are already the products of a pooling operation, for example, embedding vectors, the pooling operation of FIG. 8 may not be performed.

FIG. 8 illustrates that the first and second pooled embedding representations 85 and 86 are aggregated by an addition operation, but the present disclosure is not limited thereto. The inventors of the present disclosure have proven mathematically that the integration (or aggregation of embedding vectors via addition and multiplication operations may preserve the information (or expressive power) of embedding representations. Also, as the size (or the dimension quantity) of an integrated embedding representation does not increase regardless of an increase in the number of individual embedding representations to be aggregated, problems such as an increase in the complexity of any associated task (e.g., a downstream task such as classification or regression) may be easily addressed.

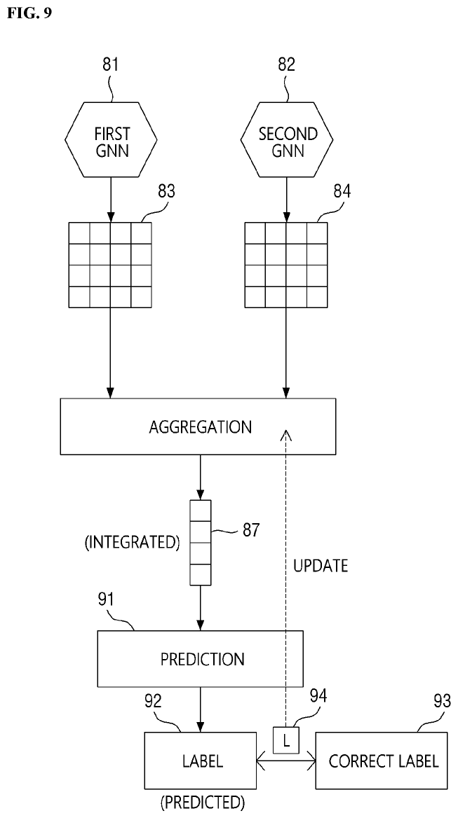

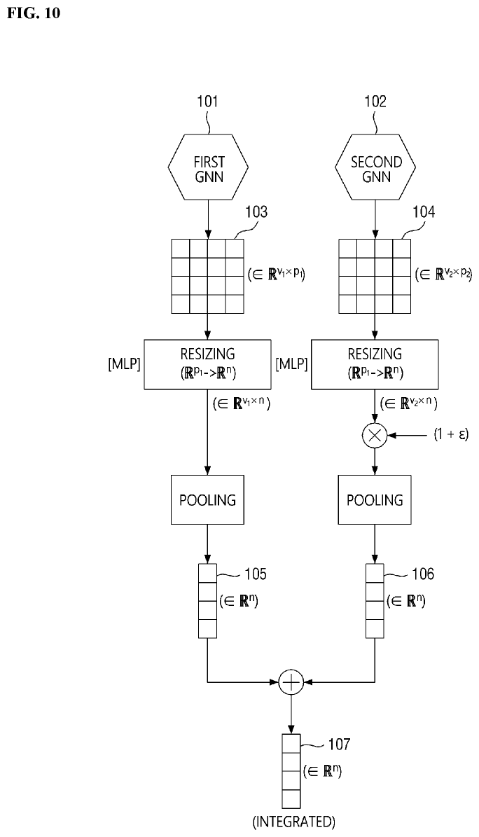

Although not specifically illustrated in FIG. 7, the graph embedding system 10 may learn modules and parameters necessary for generating an integrated embedding representation, by performing a predefined task (i.e., a task for learning). Specifically, referring to FIG. 9, the graph embedding system 10 may predict a label 92 (e.g., a class label) of the target graph by inputting an integrated embedding representation 87 to a prediction module (or layer) 91, which is task-specific. Then, the graph embedding system 10 may learn the necessary modules and parameters (e.g., the prediction module 91, a parameter for deducing a specific value, and a resizing module and first and second GNNs 81 and 82 of FIG. 10) based on loss 94, which is the difference between the prediction label 92 and a correct label 93 of the target graph. This learning process may be repeatedly performed on multiple graphs with their correct labels 93 already given, i.e., on a training set.

If the predefined task is a classification task, the prediction module 91 may be implemented as a neural network layer (e.g., a fully-connected layer) configured to be able to predict class tables, but the present disclosure is not limited thereto. That is, the structure of the prediction module 91 may vary.

According to the graph embedding method of FIGS. 7 through 9, an integrated embedding representation of a target graph may be generated by reflecting a specific value into at least some of a variety of individual embedding representations and aggregating the individual embedding representations. Due to the reflection of the specific value, different embedding representations may be prevented from cancelling each other out during aggregation, and thus, various embedding representations may be aggregated without loss of information (or expressive power). For example, the cancellation of different embedding representations during aggregation (e.g., addition) may be effectively prevented by multiplying at least one of the different embedding representations by an irrational number. Also, various embedding representations (e.g., embedding vectors) of the target graph may be aggregated by an addition operation. Also, as the size (or dimension quantity) of an integrated embedding representation does not increase regardless of an increase in the number of individual embedding representations to be aggregated, problems such as an increase in the complexity of any associated task (e.g., a downstream task such as classification or regression) may be easily addressed.

A graph embedding method according to some embodiments of the present disclosure will hereinafter be described with reference to FIG. 10, focusing mainly on the differences with the previous embodiments.

The embodiment of FIG. 10 relates to a method of generating an integrated embedding representation 107 by using a resizing operation (or module) when first and second embedding representations 103 and 104 have different sizes (e.g., different embedding matrix sizes or different vector dimension quantities). Referring to FIG. 10, it is assumed that the first and second embedding representations 103 and 104 are embedding matrices generated by different GNNs, i.e., first and second GNNs 102 and 102.

Specifically, the graph embedding system 10 may perform a resizing operation on the first and second embedding representations 103 and 104. For example, if the first and second embedding representations 103 and 104 are matrix-type representations, the graph embedding system 10 may adjust the size of the first and second embedding representations 103 and 104 by a matrix size-resizing operation. FIG. 10 illustrates that the resizing operation is performed to match the lengths of last dimensions p₁ and p₂ of the first and second embedding representations 103 and 104 (or the dimension quantities of first and second embedding vectors 105 and 106 obtained by a pooling operation), but the present disclosure is not limited thereto. Also, FIG. 10 illustrates that the resizing operation is performed based on a multilayer perceptron. The multilayer perceptron may naturally change the size of an input embedding matrix by multiplying the input embedding matrix by a weight matrix (or weight parameters), but the present disclosure is not limited thereto. That is, the resizing operation may be implemented in various other manners.

Thereafter, the graph embedding system 10 may perform operations, such as a specific value reflection operation and a pooling operation, and may generate the integrated embedding representation 107. For example, the graph embedding system 10 may generate a vector-type integrated embedding representation 107 by performing an addition operation on the first and second embedding vectors 105 and 106, which are obtained by the pooling operation.

FIG. 10 illustrates that the resizing operation is performed on both the first and second embedding representations 103 and 104, but alternatively, the resizing operation may be performed only on one of the first and second embedding representations 103 and 104.

Also, FIG. 10 illustrates that the resizing operation is performed before the pooling operation, but alternatively, the resizing operation may be performed after the pooling operation. For example, the resizing operation may be performed on the first and second embedding vectors 105 and 106, which are obtained by the pooling operation.

Also, FIG. 10 illustrates the resizing operation is performed before the reflection of a specific value of, for example, (1+ε), but alternatively, the resizing operation may be performed after the reflection of the specific value.

In some embodiments, a multilayer perceptron may be applied even to a case where the first and second embedding representations 103 and 104 have the same size. In this case, the multilayer perceptron may convert the first and second embedding representations 103 and 104 to an appropriate embedding space (e.g., a space of other embedding representations or a common embedding space) and may thus also be referred to as a conversion module or layer or as a projection module or layer.

According to the graph embedding method of FIG. 10, even embedding representations (e.g., embedding matrices) having different sizes may be easily integrated by a resizing operation implemented based on a multilayer perceptron.

A graph embedding method according to some embodiments of the present disclosure will hereinafter be described with reference to FIG. 11, focusing mainly on the differences with the previous embodiments.

The embodiment of FIG. 11 relates to a method of generating an integrated embedding representation 116 by aggregating (or integrating) k embedding representations (where k is a natural number of 3 or greater), i.e., first through k-th embedding aggregations 112-1 through 112-k. Referring to FIG. 11, it is assumed that the first through k-th embedding representations 112-1 through 112-k are embedding matrices of different sizes, generated by different GNNs, i.e., first through k-th GNNs 111-1 through 111-k.

Specifically, the graph embedding system 10 may perform a resizing operation on the first through k-th embedding representations 112-1 through 112-k and may reflect a specific value 113 or 114 in all or some of the first through k-th embedding representations 112-1 through 112-k. The specific values 113 and 114 may be different values (e.g., different irrational numbers) or may be values based on different learnable parameters. For example, the specific value 113, which is reflected into the second embedding representation 112-2, may be a first irrational number, and the specific value 114, which is reflected into the k-th embedding representation 112-k, may be a second irrational value different from the first irrational number. Accordingly, the first through k-th embedding representations 112-1 through 112-k may be effectively prevented from canceling each other out during aggregation (e.g., addition).

Thereafter, the graph embedding system 10 may perform a pooling operation and may generate the integrated embedding representation 116 by aggregating first through k-th embedding representations 115-1 through 115-k obtained by the pooling operation. For example, the graph embedding system 10 may generate the integrated embedding representation 116 by performing an addition operation on the first through k-th embedding representations 115-1 through 115-k obtained by the pooling operation.

A graph embedding method according to some embodiments of the present disclosure will hereinafter be described with reference to FIGS. 12 and 13, focusing mainly on the differences with the previous embodiments.

The embodiment of FIG. 12 relates to a method of generating an integrated embedding representation 125, which has both neighbor node information and topology information of a target graph 121 reflected thereinto, using an integrated GNN. Referring to FIG. 12, the integrated GNN may be understood as being based on the fact that two different types of GNNs, i.e., neighbor node information aggregation scheme- and topology information extraction scheme-based GNNs (e.g., the GNNs 30 and 50 of FIGS. 3 and 5), share a module for aggregating neighbor node information, i.e., a neural network. The integrated GNN may also be understood as first and second GNNs (e.g., the GNNs 30 and 50) sharing a node information aggregation module 122 together.

Specifically, the graph embedding system 10 may generate a first embedding representation 123 or 124 of the target graph 121 via the neighbor node information aggregation module 122. The first embedding representation 123 may be of a 3D matrix type, and the first embedding representation 124 may be of a 2D matrix type.

Thereafter, the graph embedding system 10 may extract topology information of the target graph 121 by analyzing the first embedding representation 123 or 124, and may generate a second embedding representation (not illustrated) by reflecting the extracted topology information.

Thereafter, the graph embedding system 10 may perform operations, such as a resizing operation, a specific value reflection operation, and a pooling operation, on the first embedding representation 123 or 124 and the second embedding representation, and may generate the integrated embedding representation 125 by aggregating the results of the operations. For example, the graph embedding system 10 may generate the integrated embedding representation 125, which is of a vector type.

The graph embedding method of FIG. 12 will hereinafter be described in further detail with reference to FIG. 13.

FIG. 13 illustrates the integrated GNN of FIG. 12. The integrated GNN of FIG. 13 may be understood as being a GNN obtained by integrating, for example, the GNNs 40 and 60 of FIGS. 4 and 6.

Referring to FIG. 13, the graph embedding system 10 may generate a first embedding representation 133 of a target graph via a neighbor node information aggregation module 132. FIG. 13 illustrates how the neighbor node information aggregation module 132 receives a feature matrix 131 (e.g., a 3D matrix having a size of v*v*d where v denotes the number of nodes and d denotes the dimension quantity of each feature) for a node tuple and outputs (or generates) an embedding matrix 133 (e.g., a 3D matrix having a size of v*v*p).

Thereafter, the graph embedding system 10 may generate a second embedding representation 135 having topology information of the target graph 131 reflected thereinto by calculating a persistence diagram using the first embedding representation 133. For example, if the first embedding representation 133 is a 3D embedding matrix, the graph embedding system 10 may generate a 2D embedding matrix 134 by extracting diagonal elements of the 3D embedding matrix, and may generate the 2D embedding representation 135 by calculating a persistence diagram for the 2D embedding matrix 134. Here, the diagonal elements of the 3D embedding matrix are extracted because they are where node information is integrated. Obviously, the 2D embedding matrix 134 may be generated in various other manners.

Thereafter, the graph embedding system 10 may obtain embedding representations 137-1 and 137-2 by performing operations, such as a resizing operation, a specific value reflection operation, and a pooling operation, on the first and second embedding representations 133 and 135, and may generate an integrated embedding representation 138 by aggregating the embedding representations 137-1 and 137-2.

According to the graph embedding method of FIGS. 12 and 13, an integrated embedding representation having both node information and topology information of a target graph reflected thereinto may be easily generated using an integrated GNN, and by using the integrated GNN, the performance of various tasks associated with graphs may be generally improved.

Experimental results regarding the performance of the above-described graph embedding methods (hereinafter, the proposed methods) according to some embodiments of the present disclosure will hereinafter be described.

The inventors of the present disclosure conducted an experiment on the proposed methods to evaluate the accuracy of a graph classification task using the MUTAG, PTC, PROTEINS, and NCH datasets, which are bioinformatics datasets, in consideration that the higher the accuracy of such task, the better the performance of the proposed methods. Specifically, the inventors of the present disclosure generated integrated embedding representations via integrated GNNs, such as that illustrated in FIG. 13, and predicted the classes of input graphs using the generated integrated embedding representations. The inventors of the present disclosure conducted the same experiment on PPGNs, which are representative neighbor node information aggregation scheme-based GNNs, and the results of the experiment are as shown in Table 1 below.

TABLE 1

| Classification | MUTAG | PTC | PROTEINS | NCI1 |
|---|---|---|---|---|
| PPGNs | 90.55 | 66.17 | 77.2 | 83.19 |
| Proposed Methods | 92.78 | 70.88 | 78.11 | 84.67 |

As is clear from Table 1, the proposed methods exhibit better performance than PPGNs, regardless of the types of the datasets, presumably, because integrated embedding representations generated by the proposed methods not only include node information, but also topology information of the input graphs. This shows that the proposed methods may produce more robust embedding representations than neighbor node information aggregation scheme-based GNNs and may hardly cause loss of information (or expressive power) during the generation of integrated embedding representations.

Also, the inventors of the present disclosure conducted an experiment on the proposed methods to evaluate the accuracy of a regression task using the Quantum Machines 9 (QM9) dataset, which is a bioinformatics dataset. Specifically, the inventors of the present disclosure generated integrated embedding representations using integrated GNNs, such as that illustrated in FIG. 13, predicted the values of the targets listed in Table 2 below, and measured the average absolute errors for the predicted values. The inventors of the present disclosure conducted the same experiment on PPGNs, and the results of the experiment are as shown in Table 2 below.

TABLE 2

| Target | PPGN | Proposed Method |
|---|---|---|
| Dipole moment | 0.231 | 0.0844 |
| Isotropic Polarizability | 0.382 | 0.0181 |
| Highest Occupied Molecular | 0.00287 | 0.00169 |
| Orbital Energy | | |
| Lowest Occupied Molecular | 0.00309 | 0.0018 |
| Orbital Energy | | |

As is clear from Table 2, the proposed methods exhibit better performance than PPGNs, even for the regression task, and this shows that the proposed methods may generally improve the performance of various tasks associated with graphs.

An exemplary computing device that may implement the graph embedding system 10 will hereinafter be described with reference to FIG. 14.

FIG. 14 is a hardware configuration view of a computing device (or apparatus) 140.

Referring to FIG. 14, the computing device 140 may include at least one processor 141, a bus 143, a communication interface 144, a memory 142, which loads a computer program 146 to be executed by the processor 141, and a storage 145, which stores the computer program 146. FIG. 14 illustrates only components of the computing device 140 that are associated with the present disclosure, but obviously, the computing device 140 may further include various other general-purpose components. That is, the computing device 140 may also include various components in addition to those illustrated in FIG. 14. Also, in some embodiments, some of the components illustrated in FIG. 14 may be omitted from the computing device 140. The elements of the computing device 140 will hereinafter be described.

The processor 141 may control the general operations of the other elements of the computing device 140. The processor 141 may be configured to include at least one of a central processing unit (CPU), a microprocessor unit (MPU), a microcontroller unit (MCU), a graphics processing unit (GPU), and another arbitrary processor that is already well known in the art to which the present disclosure pertains. The processor 141 may perform an operation for at least one application or program for executing operations and/or methods according to some embodiments of the present disclosure. The computing device 140 may include at least one processor 141.

The memory 142 may store various data, commands, and/or information. The memory 142 may load the computer program 146 from the storage 145 to execute the operations and/or methods according to some embodiments of the present disclosure. The memory 142 may be implemented as a volatile memory such as a random-access memory (RAM), but the present disclosure is not limited thereto.

The bus 143 may provide a communication function between the other elements of the computing device 140. The bus 143 may be implemented as an address bus, a data bus, a control bus, or the like.

The communication interface 144 may support wired/wireless Internet communication for the computing device 140. The communication interface 144 may also support various communication methods other than Internet communication. To this end, the communication interface 144 may be configured to include a communication module that is well known in the art to which the present disclosure pertains.

The storage 145 may non-transitorily store at least one computer program 146. The storage 145 may be configured to include a nonvolatile memory such as a read-only memory (ROM), an erasable programmable ROM (EPROM), an electrically erasable programmable ROM (EEPROM), or a flash memory, a hard disk, a removable disk, or another arbitrary computer-readable recording medium that is well known in the art to which the present disclosure pertains.

The computer program 146 may include one or more instructions that allow the processor 141 to perform the operations and/or methods according to some embodiments of the present disclosure, when loaded in the memory 142. That is, the processor 141 may perform the operations and/or methods according to some embodiments of the present disclosure by executing the loaded instructions.

For example, the computer program 146 may include one or more instructions for performing the operations of: acquiring first and second embedding representations of a target graph; changing the second embedding representation by reflecting a specific value into the second embedding representation; and generating an integrated embedding representation by aggregating the first embedding representation and the changed second embedding representation. In this example, the graph embedding system 10 may be implemented by the computing device 140.

In some embodiments, the computing device 140 may refer to a virtual machine implemented based on cloud technology. For example, the computing device 140 may be a virtual machine run on one or more physical servers included in a server farm. In this example, at least some of the processor 141, the memory 142, and the storage 145 may be virtual hardware, and the communication interface 144 may be implemented as a virtualized networking element such as a virtual switch.

The exemplary computing device 140 that may implement the graph embedding system 10 has been described so far with reference to FIG. 14.

Embodiments of the present disclosure have been described above with reference to FIGS. 1 through 14, but the present disclosure is not limited thereto and may be implemented in various different forms. It will be understood that the present disclosure may be implemented in other specific forms without changing the technical spirit or gist of the present disclosure. Therefore, it should be understood that the embodiments set forth herein are illustrative in all respects and not limiting.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results may be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications may be made to the example embodiments without substantially departing from the principles of the present disclosure. Therefore, the disclosed example embodiments of the disclosure are used in a generic and descriptive sense only and not for purposes of limitation.

What is claimed is:

1. A graph embedding method performed by at least one computing device, the graph embedding method comprising:
acquiring a first embedding representation and a second embedding representation of a target graph;
changing the second embedding representation by reflecting a specific value into the second embedding representation; and
generating an integrated embedding representation by aggregating the first embedding representation and the changed second embedding representation.

2. The graph embedding method of claim 1, wherein
one of the first embedding representation and the second embedding representation is generated by an embedding method that aggregates information of neighbor nodes that form the target graph, and
the other one of the first embedding representation and the second embedding representation is generated by an embedding method that reflects topology information of the target graph.

3. The graph embedding method of claim 1, wherein the first embedding representation and the second embedding representation are generated by embedding the target graph via different graph neural networks (GNNs).

4. The graph embedding method of claim 1, wherein the specific value is an irrational number.

5. The graph embedding method of claim 1, wherein the specific value is a value based on a learnable parameter, and
wherein the graph embedding method further comprises:
predicting a label for a predefined task based on the integrated embedding representation; and
updating a value of the learnable parameter based on a result of the predicting.

6. The graph embedding method of claim 1, wherein
the reflecting comprises reflecting the specific value into the second embedding representation based on a multiplication operation, and
the aggregating comprises aggregating the first embedding representation and the changed second embedding representation based on an addition operation.

7. The graph embedding method of claim 1, wherein the acquiring the first embedding representation and the second embedding representation comprises:
acquiring a first embedding matrix and a second embedding matrix of the target graph, the first embedding matrix and the second embedding matrix having different sizes; and
acquiring the first embedding representation and the second embedding representation by performing a resizing operation on at least one of the first embedding matrix and the second embedding matrix.

8. The graph embedding method of claim 7, wherein the resizing operation is implemented by a multilayer perceptron.

9. The graph embedding method of claim 7, wherein the generating the integrated embedding representation comprises:
generating a first embedding vector by performing a pooling operation on the first embedding representation;
generating a second embedding vector, which has the same dimension quantity as the first embedding vector, by performing a pooling operation on the changed second embedding representation; and
generating a vector-type integrated embedding representation based on the first embedding vector and the second embedding vector.

10. The graph embedding method of claim 1, wherein the acquiring the first embedding representation and the second embedding representation comprises:
acquiring the first embedding representation via a neighbor node information aggregation scheme-based GNN; and
acquiring the second embedding representation by extracting topology information of the target graph using the first embedding representation.

11. The graph embedding method of claim 10, wherein the first embedding representation is a three-dimensional (3D) embedding matrix generated by aggregating a feature matrix for a node tuple, and
wherein the generating the second embedding representation comprises:
generating a two-dimensional (2D) embedding matrix by extracting diagonal elements of the 3D embedding matrix; and
extracting the topology information of the target graph by analyzing the 2D embedding matrix.

12. The graph embedding method of claim 10, wherein the extracting the topology information of the target graph is performed by calculating a persistence diagram.

13. The graph embedding method of claim 1, wherein the generating the integrated embedding representation comprises:
performing a pooling operation on the first embedding representation and the changed second embedding representation; and
generating the integrated embedding representation by aggregating results of the pooling operation.

14. The graph embedding method of claim 1, wherein the generating the integrated embedding representation comprises:
acquiring a third embedding representation of the target graph;
changing the third embedding representation by reflecting another specific value into the third embedding representation; and
generating the integrated embedding representation by aggregating the first embedding representation, the changed second embedding representation, and the changed third embedding representation.

15. The graph embedding method of claim 1, wherein the generating the integrated embedding representation comprises:
acquiring a third embedding representation through a k-th embedding representation (k being a natural number of 3 or greater);
changing the third embedding representation through the k-th embedding representation by reflecting another specific value into the third embedding representation through the k-th embedding representation; and
generating the integrated embedding representation by aggregating the first embedding representation, the changed second embedding representation, and the changed third embedding representation through k-th embedding representation.

16. A graph embedding system comprising:
at least one processor; and
a memory configured to store program code executable by the at least one processor, the program code comprising:
acquiring code configured to cause the at least one processor to acquire a first embedding representation and a second embedding representation of a target graph;
changing code configured to cause the at least one processor to change the second embedding representation by reflecting a specific value into the second embedding representation; and
generating code configured to cause the at least one processor to generate an integrated embedding representation by aggregating the first embedding representation and the changed second embedding representation.

17. A non-transitory computer-readable recording medium storing program code executable by at least one processor, the program code comprising:
acquiring code configured to cause the at least one processor to acquire a first embedding representation and a second embedding representation of a target graph;
changing code configured to cause the at least one processor to change the second embedding representation by reflecting a specific value into the second embedding representation; and
generating code configured to cause the at least one processor to generate an integrated embedding representation by aggregating the first embedding representation and the changed second embedding representation.
